(19) United States
(12) Patent Application Publication
(10) Pub. No.: US 2024/0271649 A1
(43) Pub. Date: Aug. 15, 2024

(54) CONNECTION FITTING

(71) Applicant: Franz-Josef LANGHORST, Lippstadt (DE)

(72) Inventor: Franz-Josef LANGHORST, Lippstadt (DE)

(21) Appl. No.: 18/359,045

(22) Filed: Jul. 26, 2023

(30) Foreign Application Priority Data
Feb. 13, 2023 (DE) 202023100670.1

(51) Int. Cl. F16B 12/30; F16B 12/36

(52) U.S. Cl. CPC F16B 12/30; F16B 12/36; F16B 2012/103; F16B 2012/106

(57) ABSTRACT

A connection fitting for insertion into a receptacle of a first furniture part in an insertion direction, having a main body having an opening for receiving a connection element, in particular a bolt, which can be connected to a second furniture part, the main body having a fixing element for fixing the connection element in the main body, the connection fitting having a screw-in thread which axially adjoins the main body in the insertion direction and has a first tool holder which is accessible through the opening and is spaced apart from the opening in the insertion direction. A furniture part connection arrangement including the connection fitting and a screw tool for assembling the connection fitting also are disclosed.

### CROSS REFERENCE TO RELATED APPLICATIONS

This patent application claims priority on and the benefit of German Patent Application No. 20 2023 100 670.1 having a filing date of 13 Feb. 2023.

### BACKGROUND OF THE INVENTION

### Technical Field

The invention relates to a connection fitting, a furniture part connection arrangement, and a screw tool.

### Prior Art

Furniture parts, such as carcass walls, intermediate floors and the like, are generally connected to one another by connection fittings and then form a furniture part connection arrangement. Such an arrangement is known, for example, from DE 10 2015 219 778 A1. The basis of this furniture part connection arrangement is the connection of two components, a receptacle being provided in a first furniture part, into which receptacle a connection fitting in the form of an insert part is inserted and fixed therein. This insert part is used to receive an eccentric bolt which is fastened to a further furniture part, and to fix it by means of an eccentric fitting which is rotatably arranged in the insert part. The insert part is generally inserted into a corresponding recess in the narrow side of a furniture part, generally in the narrow side of a furniture panel. The advantage of this arrangement is that only holes having a small diameter are required in the furniture part itself, in order to insert a tool for fixing the connection. This results in visually more pleasing visible sides of furniture parts, because less thick openings can be realized in visible sides by the mentioned construction. Since there are still deviations due to tolerances, it is helpful to make the receptacle slightly deeper than the insert part is long in the insertion direction. As a result, it can of course happen that the insert part is inserted too deeply into the receptacle during assembly. There are different possibilities for fixing the insert part in the furniture part and in the process orienting it in such a way that the fixing element is accessible from the outside by means of a tool. For example, the insert part can be screwed or glued into the furniture part.

In the case of the screw-in solution in which a thread is arranged on the insert part, care should be taken that the screw-in operation does not damage either the insert part or the furniture part, since the stability of the furniture part connection arrangement suffers as a result of this.

### BRIEF SUMMARY OF THE INVENTION

It is therefore an object of the present invention to specify a connection fitting, during the fastening of which to a furniture part, said part itself, and also the connection fitting, is not damaged.

This object is achieved by a connection fitting for insertion into a receptacle of a first furniture part in an insertion direction, comprising a main body having an opening for receiving a connection element, in particular a bolt, which can be connected to a second furniture part, wherein the main body comprises a fixing element for fixing the connection element in the main body, wherein the connection fitting comprises a screw-in thread which axially adjoins the main body in the insertion direction and has a first tool holder which is accessible through the opening and is spaced apart from the opening in the insertion direction. Advantageous embodiments can be found in the dependent claims.

The connection fitting according to the invention serves for insertion into a receptacle of a first furniture part in an insertion direction. For this purpose, the connection fitting has a main body having an opening for receiving a connection element, in particular a bolt, which can be connected to a second furniture part. The main body comprises a fixing element for fixing the connection element in the main body. “Comprise” does not mean that the fixing element must be inseparably connected to the main body. According to a preferred embodiment, it can be screwed into the main body. The connection fitting further comprises a screw-in thread which axially adjoins the main body in the insertion direction. This has a first tool holder which is accessible through the opening and spaced apart from the opening in the insertion direction.

It is particularly advantageous here that the tool holder is arranged in such a way that the force, which a screw tool received therein exerts on the connection fitting, can be introduced directly into the section on which the screw-in thread is arranged. A force is thus introduced directly, and not indirectly via the main body. This prevents stresses arising between the screw-in thread and the main body during screwing in, which stresses can lead to damage of the connection fitting. In addition, the main body can be kept relatively short in the axial insertion direction so that material can also be saved. The main body must merely be dimensioned in such a way that, preferably in its wall, at least one receptacle for the fixing element is accommodated.

It is preferably provided that the first tool holder is at a distance from the opening and is preferably arranged in the transition region of the screw-in thread and main body. Thus, the introduction of force via a screw tool can be best transferred to the screw-in thread.

The connection fitting can be formed in one piece in that the screw-in thread and the main body are formed in one piece. A further embodiment provides that the screw-in thread is designed as a screw-in sleeve, for example as a threaded insert, which is screwed to a counter-thread in the main body provided in the end face of the main body that is at the front in the insertion direction, or is rotatably connected to the main body, even without a thread. In this way it is possible to screw the screw-in thread into the first furniture part without necessarily also rotating the main body. During positioning of the main body and the receptacle for the fixing element present therein relative to a hole in the first furniture part, this can help to align the hole with the receptacle and thus enable the fixing of the fixing element to the connection element of the other furniture part.

Furthermore, the first tool holder can be integrally formed with the part of the connection fitting having the screw-in thread. In this way, a particularly good force transmission from the screw tool to the screw-in thread is achieved.

In the case of a multi-part design of the connection fitting, it can be provided that the main body has a stop for contact with the screw-in sleeve. This serves to limit the relative movement of the two parts.

The fixing element is preferably a fixing screw or grub screw that can be inserted or is inserted into at least one threaded hole provided in the main body. In this case, the axial direction of the threaded hole is preferably perpendicular to the insertion direction. Of course, a plurality of threaded holes can be distributed over the periphery of the main body, for example at intervals of 90°, 60°, 120° or 180°, which can be helpful in the above-described flush alignment with the hole in the first furniture part.

The main body preferably has an enveloping surface or outer contour having a circular cross section. In this way, the main body can also rotate when the screw-in thread is screwed in.

In principle, various materials are conceivable for the connection fitting according to the invention, for example plastic. According to a preferred embodiment, the main body and/or the screw-in thread is/are formed from a metal material, preferably a metal solid material or casting material. This allows a particularly stable design so that the connection fitting can absorb and pass on forces of at least 500 N.

According to an advantageous embodiment, it can be provided that, in the insertion direction, an axial hole for receiving the section of a tool tip adjoins the section having the first tool holder. In this way, it is possible to tighten not only the screw-in thread but also the fixing element using a single tool. In this case, it is particularly advantageous if the axial hole has a smaller diameter than the first tool holder. In this embodiment, it is possible to design a corresponding screw tool such that it tapers towards its end remote from the handle. The front section could then dip into the axial hole while another section of a screw tool engages in the first tool holder.

The invention therefore relates to a screw tool for assembling an above-described connection fitting. For this purpose, the screw tool has a first engagement section for form-fitting and/or force-fitting engagement in a first tool holder, and a second engagement section for form-fitting and/or force-fitting engagement in a further second tool holder different from the first tool holder. Thus, using a single tool, both the connection fitting can be screwed into a first furniture part, and the fixing element can be mounted such that it holds a connection element in the main body.

It can advantageously be provided that the screw tool has an end remote from a handle section, the second engagement section being arranged closer to this end and having a smaller enveloping surface diameter than the first engagement section.

Finally, the invention relates to a furniture part connection arrangement having a first furniture part and a second furniture part which is connected thereto, and to an above-described connection fitting. In this case, a receptacle for receiving the connection fitting is provided in a first side of the first furniture part, into which receptacle the connection fitting is introduced and screwed by means of the screw-in thread. Furthermore, a connection element fastened to the second furniture part is provided, which element is inserted into the opening of the connection fitting in the insertion direction and is secured therein by means of the fixing element.

### BRIEF DESCRIPTION OF THE DRAWINGS

The invention will be explained in more detail in the following with reference to FIGS. 1 to 4.

FIG. 1 shows a perspective transparent view of a connection fitting according to the invention.

FIG. 2 shows a longitudinal sectional view through a connection fitting according to the invention according to a first embodiment.

FIG. 3 shows a longitudinal sectional view through a connection fitting according to the invention according to a second embodiment.

FIG. 4 shows a perspective view of a part of a screw tool according to the invention.

### DETAILED DESCRIPTION OF PREFERRED EMBODIMENTS

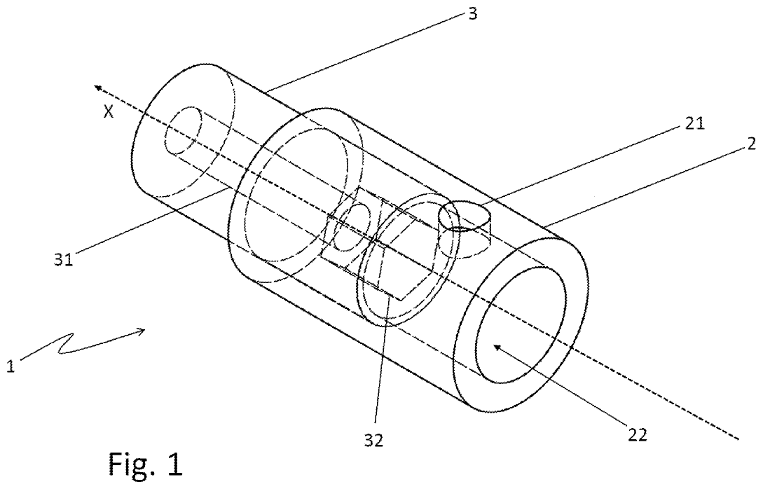

The connection fitting 1 shown in FIG. 1 has a main body 2 which is preferably—as is preferably the rest of the connection fitting-rotationally symmetrical, or at least formed with a circular enveloping surface. The main body 2 has an opening 22 which leads into the interior of the main body 2. According to the invention, this connection fitting 1 is inserted into a first furniture part, and a connection element (not shown here) is then inserted through the opening 22 into the interior of the main body 2 and fixed in the interior. This is done by a fixing element (not shown here) which can be a fixing screw, for example, which can be designed, for example, in the form of a grub screw. Such a fixing screw could then be screwed, for example, through a corresponding threaded hole 21 into the interior of the main body 2 in order to fix a connection element, for example a bolt or the like, which is attached to a second furniture part.

First, however, the connection fitting 1 according to the invention is to be fastened in a first furniture part. For this purpose, a screw-in thread 3 is used which axially adjoins the substantially cylindrical main body 2 in the insertion direction X. The screw-in thread 3 can be part of a separate component which is connected to the main body 2, but can also be integrally formed therewith. In the region of the transition between the main body 2 and the screw-in thread 3, a first tool holder 32 is arranged which-the front opening of which-is spaced apart from the opening 22 of the main body 2 and therefore only begins in the interior of the main body 2. This has the advantage that the tool holder 32 is placed in such a way that a screw tool, which is inserted into the tool holder 32, primarily exerts the rotational force on the screw-in thread 3 and not, or predominantly not, on the main body 2. The section 3 having the screw-in thread 33 can have an axial hole 31 which makes it possible for at least a part of the screw tool (not shown here) to reach through the tool holder 32 into the axial hole 31.

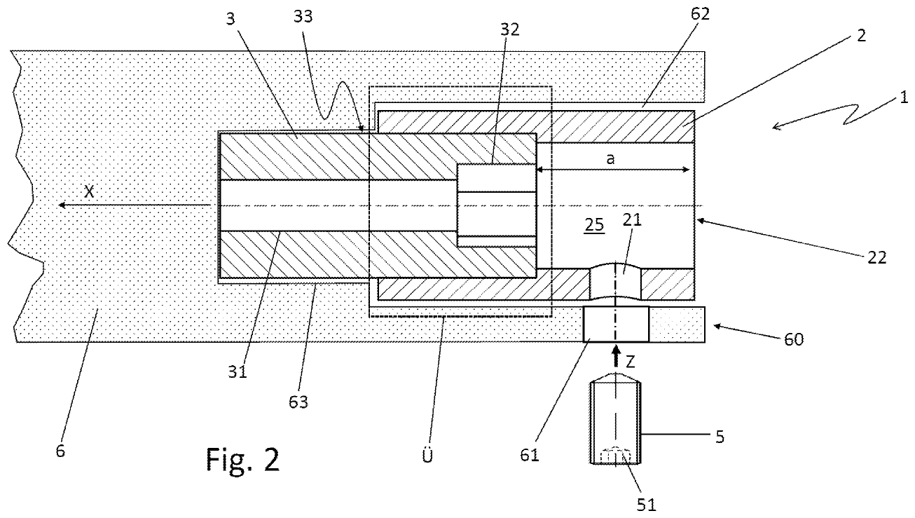

FIG. 2 shows, in a longitudinal sectional view along the insertion direction X, how the connection fitting 1 according to the invention is inserted into a first furniture part 6. Preferably, the connection fitting 1 is inserted into the narrow side 60 of the first furniture part 6. For this purpose, a receptacle 62, 63 is provided in the interior of the first furniture part 6, which receptacle can be introduced into the furniture part 6 for example by drilling, e.g., by means of a step drill, or by milling. It can be seen that the main body 2 is located in a first region 62 of the receptacle 62, 63. A region 63, which is preferably tapered in cross section with respect thereto, adjoins the region 62 in the axial direction, i.e., in the insertion direction X. The screw-in thread 33 is screwed into this region in that a tool is inserted into the first tool holder 32 and rotated about an axis in parallel with the insertion direction X. In this case, the end position or rotation must be carried out in such a way that the threaded hole 21 is aligned with a hole 61 in a flat side of the first furniture part 6 so that a fixing element 5, for example a fixing screw, can preferably be screwed or inserted in a direction Z perpendicular to the direction X. If a fixing screw 5, for example in the form of a grub screw, is used, it has a second tool holder 51 into which a screw tool can engage. Tool holders 32, 51, are, for example, for engaging or receiving a tool tip 40 such as the tip of a screw driver.

It can also be seen that, according to the invention, viewed in the insertion direction X, the tool holder 32, more precisely the start thereof, is offset by a distance a from the opening 22 into the interior 25 of the main body 2. The tool holder 32 is thus located in a transition region Ü which marks the transition between the main body and the section 3 or the screw-in thread 33. This has the advantage that forces which are exerted on the tool holder 32 by a screw-in tool are introduced substantially into the section 3 or its thread 33 so that forces on the remaining main body 2, and thus possible damage to the connection fitting, are substantially avoided.

Of course, other fixing elements 5 can also be used, for example it is possible to place an eccentric housing in the interior 25 of the main body 2, which eccentric housing then receives and fixes a bolt or another connection element. In such a case, the opening 21 would then preferably be a simple drilled hole without a thread through which a screw tool can be inserted into the interior 25 of the main body 2.

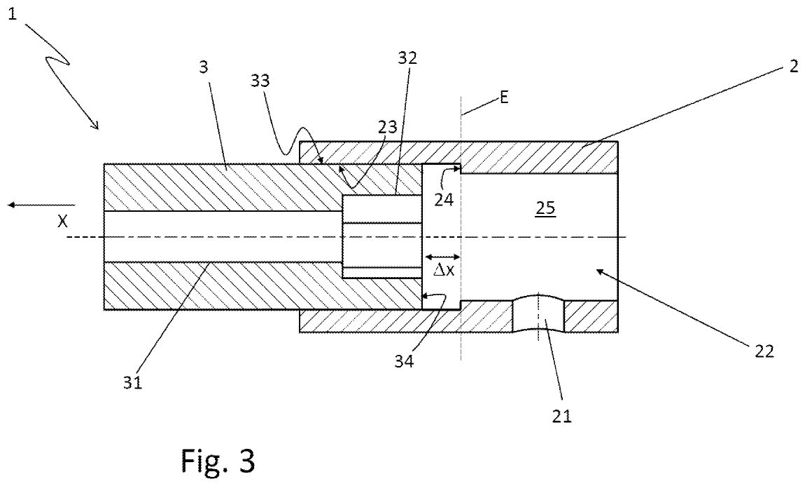

As can be seen in FIG. 2, the connection fitting according to the invention can be formed in one piece, but it is also possible that, as shown in FIG. 3, the main body 2 and the section 3 which has the screw-in thread 33 are separate components, in the example shown in FIG. 3 the screw-in thread 33 or an additional thread being screwed at this point into a corresponding threaded receptacle 23 of the main body 2. It is also conceivable for the component 3 to be mounted so as to be merely rotatable relative to the component 2. If the parts 2 and 3 are connected to one another by a thread, a relative displacement between the portion 3 and the main body 2 takes place when the section 3 is screwed into the first furniture part, which is shown in the drawing by the distance Dx. In this design, the main body 2 can preferably have a stop 24, against which a front end part 34 of the section 3 strikes. The multi-part design of the connection fitting has the advantage that a hole 21 is then easier to position relative to the hole 61 in the first furniture part. In the case of the one-piece variant of the connection fitting according to the invention, it may be necessary to provide more than one corresponding hole 21, with or without a thread, in the main body 2.

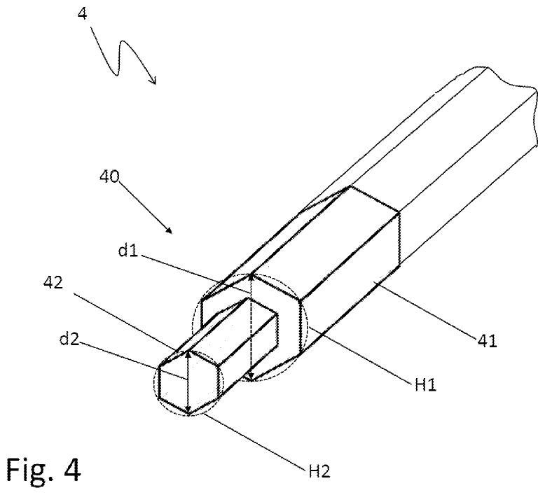

In the shown example, workpiece holders 32 and 51 are present which generally have a different cross section. Therefore, two different screw tools would usually be required for assembly. According to the invention, FIG. 4 shows a screw tool which is capable of completely assembling the connection fitting according to the invention.

FIG. 4 shows a section of a screw tool 4 according to the invention (a handle or the like is not shown). The screw tool 4 has an end section or an end 40. In the present case in the form of a hex screwdriver, other cross sections, also combinations thereof, such as torx or Phillips, are also conceivable. This end section has a wider first section 41 and a narrower second section 42 in comparison thereto, which adjoins axially. The first section 41 is designed such that it can be inserted in a form-fitting or force-fitting manner into the first tool holder 32 in order to screw the screw-in thread 33 into the first furniture part 6, cf. FIG. 2. This section 41 has a circular or cylindrical enveloping surface H1 (indicated here by a dashed circular line), which has a first diameter d1. Accordingly, the section 42 located at the outermost part of the tool 4 has a circular or cylindrical enveloping surface H1 (indicated here by a dashed circular line) which has a second diameter d2, preferably d1>d2 applying. With the aid of this screw tool 4, the first section 41 (in FIG. 2) can therefore first be inserted into the first tool holder 32, the second section 42 then being placed in the drilled hole 31. If the screw-in thread 33 is screwed sufficiently far into the region 63 of the first furniture part 6, and the main body 2 is oriented having its drilled hole 21 or one of its drilled holes aligned with the hole 61, the tool 4 is pulled out again. Then, using the same tool 4, by inserting the second section 42 into the second workpiece holder 51 of the fixing element 5, this is screwed through the hole 61 into the drilled hole 21, and a connection element (not shown) is fixed in the interior 25 of the main body in order to thereby create a furniture part connection arrangement according to the invention.

What is claimed is:

1. A connection fitting (1) for insertion into a receptacle (62) of a first furniture part (6) in an insertion direction (X), comprising a main body (2) having an opening (22) for receiving a connection element which can be connected to a second furniture part, wherein the main body (2) comprises a fixing element (5) for fixing the connection element in the main body (2), wherein the connection fitting (1) comprises a screw-in thread (33) which axially adjoins the main body (2) in the insertion direction (X) and has a first tool holder (32) which is accessible through the opening (22) and is spaced apart from the opening (22) in the insertion direction (X).

2. The connection fitting (1) according to claim 1, wherein the first tool holder (32) is at a distance (a) from the opening (22) and is arranged in the transition region (Ü) of the screw-in thread (33) and the main body (2).

3. The connection fitting (1) according to claim 1, wherein the screw-in thread (33) is a screw-in sleeve (3) which is screwed or rotatably connected to a counter-thread (23) in the main body (2) which is provided in the end face of the main body (2) that is at the front in the insertion direction (X).

4. The connection fitting (1) according to claim 1, wherein the first tool holder (32) is formed integrally with the part of the connection fitting (1) having the screw-in thread (33).

5. The connection fitting (1) according to claim 1, wherein the screw-in thread (33) and the main body (2) are formed integrally.

6. The connection fitting (1) according to claim 3, wherein the main body (2) has a stop (24) for contacting the screw-in sleeve (3).

7. The connection fitting (1) according to claim 1, wherein the fixing element (5) is a fixing screw which can be inserted or is inserted into at least one threaded hole (21) provided in the main body (2), the axial direction (Z) of the threaded hole (21) extending perpendicularly to the insertion direction (X).

8. The connection fitting (1) according to claim 1, wherein the main body (2) has an enveloping surface or an outer contour having a circular cross section.

9. The connection fitting (1) according to claim 1, wherein the main body (2) is formed from a material selected from the group consisting of a metal material, a metal solid material, and a casting material.

10. The connection fitting (1) according to claim 1, wherein in the insertion direction (X), an axial hole (31) for receiving a section (41) of a tool tip (40) adjoins the section having the first tool holder (32).

11. The connection fitting (1) according to claim 10, wherein the axial hole (31) has a smaller diameter than the first tool holder (32).

12. A furniture part connection arrangement having a first furniture part (6) and a second furniture part connected thereto, as well as a connection fitting (1) according to claim 1, wherein a receptacle (62) for receiving the connection fitting (1) is provided in a first side (60) of the first furniture part (6), into which receptacle the connection fitting (1) is introduced and screwed by means of the screw-in thread (33), wherein a connection element fastened to the second furniture part is provided, which connection element is inserted into the opening (22) of the connection fitting (1) in the insertion direction (X) and is secured therein by means of the fixing element (5).

13. A screw tool (4) for assembling a connection fitting (1) according to claim 1, comprising a first engagement section (41) for form-fitting and/or force-fitting engagement in a first tool holder (34), and a second engagement section (42) for form-fitting and/or force-fitting engagement in a further second tool holder (51) different from the first tool holder (32).

14. The screw tool (4) according to claim 13, further comprising an end (40) remote from a handle section, the second engagement section (42) being arranged closer to this end (40) and having a smaller enveloping surface diameter (d1, d2) than the first engagement section (41).
